(19) United States
(12) Patent Application Publication
(10) Pub. No.: US 2013/0180062 A1
(43) Pub. Date: Jul. 18, 2013

(54) SKIN SENSING ACTIVATED DEVICE

(71) Applicants: Gerhart P. Huy, Hamilton Square, NJ (US); Todd W. Domke, Newtown, PA (US); Stephen H. Thong, Grand Rapids, MI (US)

(72) Inventors: Gerhart P. Huy, Hamilton Square, NJ (US); Todd W. Domke, Newtown, PA (US); Stephen H. Thong, Grand Rapids, MI (US)

(73) Assignee: CHURCH & DWIGHT CO., INC., Princeton, NJ (US)

(21) Appl. No.: 13/819,036

(22) PCT Filed: Aug. 31, 2011
(86) PCT No.: PCT/US11/49887

§ 371 Date: Apr. 4, 2013

Related U.S. Application Data
(60) Provisional application No. 61/378,636, filed on Aug. 31, 2010.

(51) Int. Cl. A61C 17/16

(52) U.S. Cl. CPC A61C 17/16
USPC 15/22.1

(57) ABSTRACT

An electrical device such as an electric toothbrush that comprises a handle and a head portion. The head portion comprises a bristle bearing portion and an optional neck portion. The handle includes a housing having a housing exterior. First and second conductive contacts are located on the exterior of the housing. The first and second conductive contacts form part of a high impedance touch sensitive circuit configured to operate a motor to drive the bristle bearing portion when the handle is gripped by a user.

### CROSS-REFERENCE TO RELATED APPLICATION

This application is related to U.S. Provisional Patent Application Ser. No. 61/378,636 filed Aug. 31, 2010 and takes priority therefrom.

### FIELD OF THE INVENTION

This invention relates to hand held appliances, and more especially hand held appliances of a kind having a handle by means of which the appliance is intended to be gripped in the hand of a user, a head part that for the purpose of performing a treatment on the body of the user is brought into contact with, or at least into close proximity to, the body, and an electrical device, such as a vibration generator, operated in use of the appliance.

### BACKGROUND OF THE INVENTION

The invention is primarily intended to be utilized in turning on and off various types of electrically powered instruments having handles which are adapted to be engaged by the hand of the user during utilization of the instrument. In particular, the invention is directed to electric toothbrushes. Such instruments typically utilize internal batteries in order to obtain electric power. Normally such instruments include a conventional type of switch which has to be actuated in order to turn the instrument on or off.

It has been recognized that the utilization of such switches in hand held electrically powered instruments is relatively disadvantageous. One reason for this pertains to the usual reliability problems associated with conventional switches employing mechanical movement. The use of such switches in instruments as described is also relatively disadvantageous because of the possibility that the user of an instrument may forget to or may neglect to turn the switch on such an instrument off when the instrument itself is not being utilized.

Frequently the inclusion of a switch actuated by mechanical movement in an instrument as noted is disadvantageous for another reason. Frequently it is necessary or desirable to utilize a switch in such an instrument to control the operation and/or utilization of the instrument in other than an on/off type manner, e.g., variable speeds. In general, the use of a multifunction mechanism to accomplish switch actuation and to accomplish another control function tends to make an instrument unnecessarily complex. This in turn tends to affect instrument costs and reliability.

Further, young children and users with disabilities in the hands such as arthritic finger joints can find it hard to operate external switches on personal health care devices such as electrical toothbrushes. Therefore, there is a need for such devices with switch mechanisms that enable such devices to be easily switched on and off.

In the past it has been proposed to avoid the reliability problems associated with mechanical switches and to avoid the possibility of an instrument being laid aside while remaining turned on through the use of various types of proximity switches. While expedients of this type are also considered to be utilitarian they are also considered to be relatively undesirable. This is because an instrument as noted may be laid down upon a table or the like in such a manner that any proximity switch mechanism within the instrument is sufficiently close to one or more objects so as to be actuated by such objects. This, of course, will have the effect of leaving the instrument on when the instrument itself is not in use.

U.S. Pat. No. 7,441,336 issued to Hawes et al. describes a hand held electrical appliance having a handle and a head part to be brought into contact with the body of the user, such as a toothbrush with a brush head or a safety razor with a head part in the form of a blade unit, including an electrically operable vibration generating device, for example an electric motor and eccentric weight, and a control device for controlling operation of the vibration generating device. The control device is proximity or touch sensitive and includes a sensor element, such as an electrode formed by a blade of the blade unit, so that the vibration generating device is actuated in response to a person using the appliance and moving the blade unit (or other head part) into close proximity to or into contact with the body area to be treated.

UK (GB) Patent Application No. 2,258,922 issued to Yap et al. describes a personal-care apparatus. The personal-care apparatus comprises a load and a switch. The load and switch are coupled in series between first and second supply terminals for receiving an alternating voltage. The personal-care apparatus also comprises a rectifying circuit for converting the alternating voltage into a direct voltage, and a safety circuit, which is coupled between third and fourth supply terminals for receiving the rectifying circuit DC voltage output. The personal-care apparatus further comprises a capacitive sensor for the detection of the presence of a part of a human body in the proximity of the personal-care apparatus, the safety circuit being adapted to control the switch in response to such detection.

### SUMMARY OF THE INVENTION

An electrical device such as an electric toothbrush that comprises a handle and a head portion. The head portion comprises a bristle bearing portion and an optional neck portion. The handle includes a housing having a housing exterior. First and second conductive contacts are spaced from each other and located on the exterior of the housing. The first and second spaced conductive contacts form part of a high impedance touch sensitive circuit configured to operate a motor to drive the bristle bearing portion when the handle is gripped by a user.

Activation of the motor is achieved when the contacts are touched by human skin or tissue of a user thereby eliminating the need for external switches located on the device. The device is particularly useful for users with disabilities such as arthritis in the hands and/or fingers. A user is not required to operate a switch to start or stop the device.

### BRIEF DESCRIPTION OF THE DRAWINGS

FIG. 1 shows a perspective environmental view of a device according to the invention.

FIG. 2 shows a perspective view of the device of FIG. 1.

FIG. 3 shows a circuit schematic.

FIG. 4 shows a circuit schematic with a line representing a mechanical link between a DC motor and a bristle bearing portion of an electric toothbrush according to the present invention.

Similar reference characters denote corresponding features consistently throughout the attached drawings.

### DETAILED DESCRIPTION OF THE PREFERRED EMBODIMENTS

The present invention is directed to electric devices with internal motors. More specifically, the invention is a skin-sensing activated device such as, a skin-sensing activated toothbrush. The skin-sensing activated toothbrush of the present invention is denoted by the reference numeral 100 as a whole. The terms “skin-sensing activated device 100” and “device 100” are hereinafter regarded as equivalent terms.

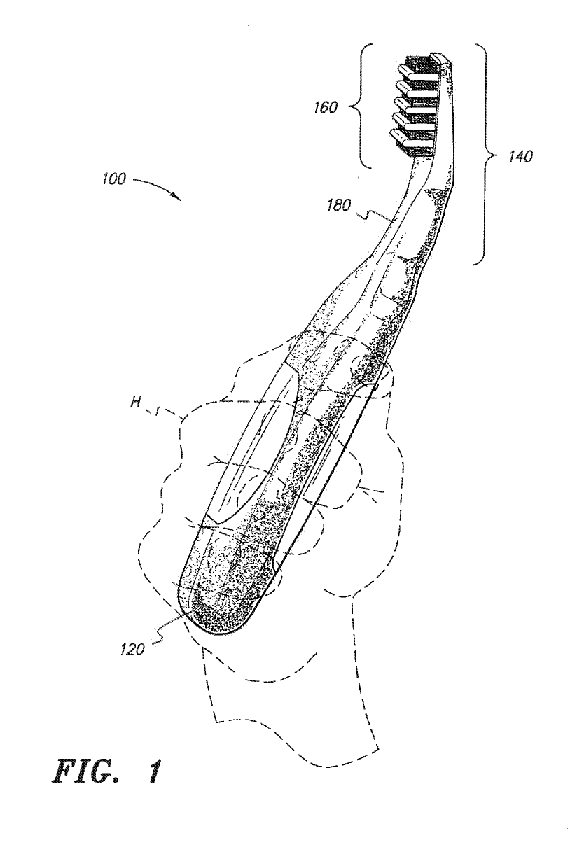

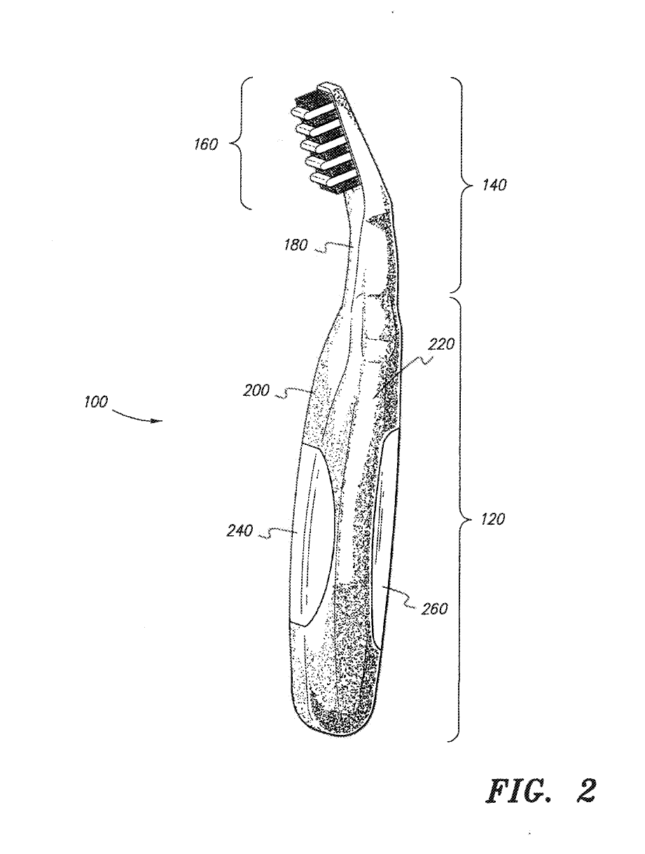

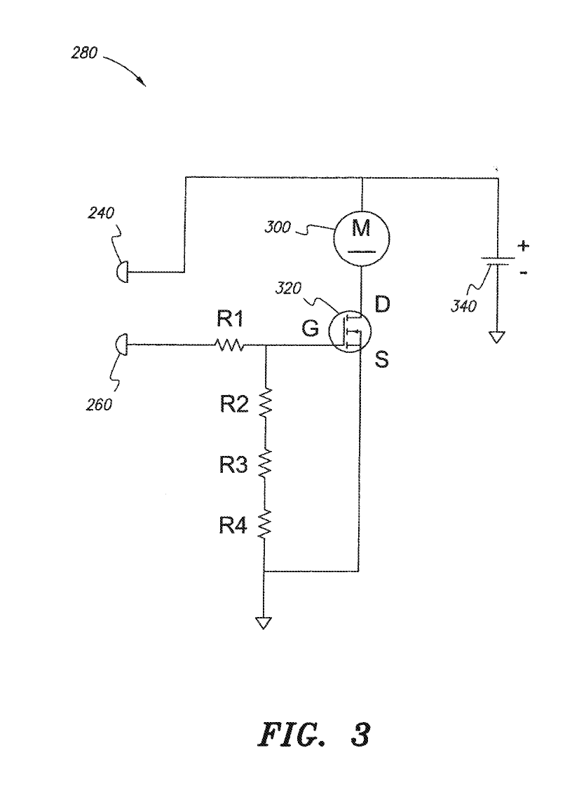

FIGS. 1 and 2 respectively show an environmental and a perspective view of device 100 according to the present invention. The device 100 includes a handle 120 and a head portion 140. The head portion 140 comprises a bristle bearing portion 160 and an optional neck portion 180. The handle 120 includes a housing 200; the housing 200 defines an exterior surface 220. First and second conductive contacts 240 and 260 are located on the exterior 220 of the housing 200 and spaced from each other. The first and second conductive contacts 240 and 260 form part of a high impedance touch sensitive circuit 280 (see FIG. 3) configured to operate the bristle bearing portion 140 when a user's hand H grips the handle 120 as shown in FIG. 1.

In a preferred embodiment the first and second contacts 220 and 240 form part of a high impedance touch sensitive circuit adapted to respond to the resistive properties of a person's hand gripping the handle 120. FIG. 3 shows an example of a high impedance touch sensitive circuit 280 responsive to the resistive properties of a person's hand upon gripping the handle 120. The high impedance touch sensitive circuit 280 differs from typical circuits used to drive devices such as electric toothbrushes in that the high impedance touch sensitive circuit 280 does not require a microcontroller CPU (central processor chip) to operate a toothbrush as required by many prior art electric toothbrushes.

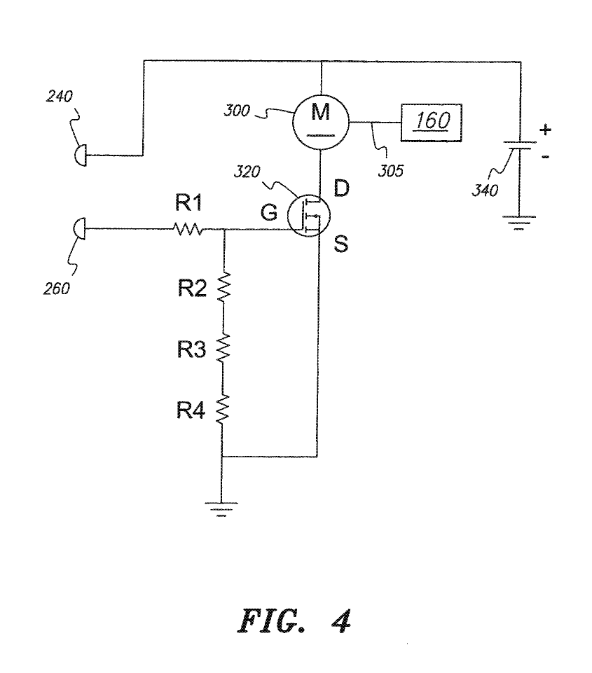

In the present invention, a user only has to grip the handle 120, and thereby cause skin or hand tissue to come into contact with the first and second contacts 240 and 260, to activate a DC motor 300 (shown in FIG. 3) and drive the bristle bearing portion 160 (see FIG. 4), and upon release of the handle 120 the motor 300 deactivates. More specifically, the high impedance touch sensitive circuit 280 responds to the resistive properties of a user's hand H to switch on or off motor 300 to drive the bristle bearing portion 160 of device 100. The DC motor 300 is mechanically coupled or operative to move the bristle bearing portion 160 by any means known in the art, e.g., mechanical linkages, eccentric motor shaft weight, etc.

The mechanical coupling between the DC motor 300 and the bristle bearing portion 160 is represented by line 305 in FIG. 4. The DC motor 300 is located inside device 100 such as in the housing 200. It should be understood that the bristle bearing portion 160 can be any suitable bristle bearing portion such as a rotatable set of bristles such as that described in U.S. Pat. Nos. 4,603,448, 5,383,242, and 6,446,294 or, for example, a set of bristles with stroke-type bristle movement as described, for example, in U.S. Pat. No. 5,974,615 or, for example, a set of bristles that vibrate such as that described in U.S. Pat. No. 5,651,157. U.S. Pat. Nos. 4,603,448, 5,383,242, 6,446,294, 5,974,615, and 5,651,157 are each incorporated herein by reference in their entirety.

The high impedance touch sensitive circuit 280 responds to the resistive properties of a person's hand H by switching on a transistor 320 (represented in FIG. 3 by an n-channel MOSFET with a gate G, drain D, and a source S). Once the transistor 320 is switched on, current flows from a battery 340 to the DC motor 300 and thence to the drain D of the transistor 320 and thence to earth via source S of transistor 320.

The circuit 280 is sufficiently tuned by means of resistors R1 through R4 to provide a switch-on voltage at gate G of transistor 320 when a user's hand H grips handle 120. Specifically, transistor 320 is switched on when a user's hand H touches first and second contacts 240 and 260 thereby switching on transistor 320 and directing current from battery 340 through DC motor 300 to drive the bristle bearing portion 160. Once a user removes their hand from the handle H the voltage on the gate side of transistor 320 drops, the transistor 320 is switched off and the battery 340 stops supplying electricity to the DC motor 300.

The battery 340 can be a replaceable battery or a rechargeable battery. If the battery 340 is a rechargeable battery then the mean time between battery recharges is increased since the device 100 is immediately switched off when the user releases the handle 120 in contrast to those prior art devices such as toothbrushes that require the user to physically switch off the device.

The bristle bearing portion 160 can take any suitable form such as, but expressly not limited to, the bristle bearing portions as described in U.S. Pat. No. 6,654,979 (issued to Calabrese) and shown as part number “4” in FIGS. 1 and 3 in the Calabrese '979 patent. U.S. Pat. No. 6,654,979 is incorporated herein by reference in its entirety.

The transistor 320 can be any suitable transistor such as, but expressly not limited to, an n-channel MOSFET able to cope with a drain current sufficiently high to run the motor 300. For example, transistor 320 could be an n-channel Si2314EDS MOSFET.

The first and second contacts 240 and 260 can be made out any suitable conducting material such a metal or metal alloy. The housing 200 can be made out of any suitable non-conducting material such as a non-conducting plastic or polymer. The motor 300 is a DC motor capable of operating the bristle bearing portion 160. The battery 340 can be a rechargeable battery such as, but not limited to, a nickel-cadmium battery, a nickel-metal hydride (Ni-MH) or a lithium-ion battery (Li-ion). Alternatively, the battery 340 is a non-rechargeable battery; for example, the battery 340 can be made up of one or more alkaline batteries such as those supplied by Duracell®.

The resistors R1 through R4 can have any suitable resistance values (in ohms) such as, but not limited to: 10K, 4.7M, 4.7M and 4.7M, respectively. It should be understood by a person of ordinary skill in the art that the number of resistors and their resistance can vary and can be ascertained without undue experimentation. For example, one or two resistors could be used in place of R2, R3 and R4. The only limitation being that the circuit 280 functions such that the circuit 280 is able to respond to the resistance properties of a person's hand and switch on the transistor 320 when a person grips handle 120, and switches off the transistor 320 when a person removes their hand H from handle 120.

In one embodiment, the contacts 240 and 260 are positioned such that should the handle 120 be in contact with a flat surface then only one of the first and second contacts 240 and 260 can be in contact with the flat surface. In this embodiment the contacts 240 and 260 cannot simultaneously be in contact with a flat surface such as a counter-top or flat area located proximate to a bathroom sink. The first and second contacts 240 and 260 can be located on opposite sides of handle 120 such that a user's hand can make contact with the first and second contacts 240 and 260 by gripping the handle 120 as shown in FIG. 1.

It should be understood that the electric toothbrush and the various elements described herein are set forth merely to facilitate a complete understanding of the device 100, and should not be read as limiting the invention to toothbrush applications. Rather the invention described herein encompasses any and all embodiments within the scope of the following claims.

What is claimed:

1. An electric toothbrush, comprising:
a handle, said handle defining a non-conducting housing, said housing defining an exterior surface, said exterior surface includes first and second spaced conductive contacts;
a head portion, said head portion includes a bristle bearing portion; and
a high impedance touch sensitive circuit, said first and second contacts forming part of said high impedance touch sensitive circuit, said circuit further comprises a DC motor operative to move said bristle bearing portion and a battery, wherein said contacts are positioned on said housing such that when a user's hand grips said handle said circuit is responsive to the resistance properties of the user's hand causing electrical current to flow from said battery through said DC motor to drive said bristle bearing portion, and upon a user releasing said handle said circuit responds by switching off said DC motor.

2. The electric toothbrush according to claim 1, wherein said high impedance touch sensitive circuit includes a transistor operating as a switch in series with a DC motor.

3. The electric toothbrush according to claim 2, wherein said transistor is an n-channel MOSFET.

4. The electric toothbrush according to claim 1, wherein said first and second spaced conductive contacts are located on opposite sides of said handle.

5. The electric toothbrush according to claim 1, wherein said head portion comprises a neck portion.

6. The electric toothbrush according to claim 1, wherein said battery is a rechargeable battery.

7. The electric toothbrush according to claim 1, wherein said battery is a non-rechargeable battery.

8. The electric toothbrush according to claim 1, wherein said first and second spaced conductive contacts are positioned such that when said handle is in contact with a flat surface, at least one of said first and second conductive contacts are in contact with said flat surface.

9. The electric toothbrush according to claim 1, wherein said first and second spaced conductive contacts comprise a metal or metal alloy.

10. The electric toothbrush according to claim 1, wherein said handle is a non-conducting plastic.
